(19) United States
(12) Patent Application Publication
(10) Pub. No.: US 2001/0052919 A1
(43) Pub. Date: Dec. 20, 2001

(54) Ink cartridge

(76) Inventors: Tz-Ya Yang, Taipei (TW); Hsien-Li Chiu, Miaoli Hsien (TW)

Correspondence Address: BIRCH STEWART KOLASCH & BIRCH, PO BOX 747, FALLS CHURCH, VA, 22040-0747, US

(21) Appl. No.: 09/735,616

(22) Filed: Dec. 14, 2000

(30) Foreign Application Priority Data
Jun. 19, 2000 (TW) 89112007

(51) Int. Cl. B41J 2/175

(52) U.S. Cl. 347/86

(57) ABSTRACT

The ink cartridge comprises a container formed with an inner space and a base plate provided with a port, a sealing mechanism used to fit in the port, and an ink supply needle used to connect the inner space and output the ink. Pluralities of capillary portions are formed on the inner sidewall of the port so as to keep the filter with ink. A positioning hole indented from one end of the sealing mechanism is used to align the ink supply needle, and a recess is provided at another end of the sealing mechanism so as to connect the inner space of the container. When the sealing mechanism has been fully inserted with the ink supply needle, the sealing mechanism clamps the ink supply needle and the ink received in the container can be smoothly transmitted via the ink supply needle. When the ink cartridge is pulled out of the ink supply needle, the piercing hole of sealing mechanism is rapidly converged and sealed the port, and then the stored ink can be kept in the container with no leakage.

### BACKGROUND OF THE INVENTION

1. Field of the Invention

This invention relates to an ink cartridge of a printing device. More particularly, this invention relates to an ink cartridge having a port, which is formed with a capillary slot to transmit ink and plugged by a sealing mechanism formed with a recess.

2. Description of Prior Art

FIG. 1A shows an exploded perspective view of the structure of a prior ink cartridge A, and FIG. 1B is a perspective view showing the assembly according to FIG. 1A.

As shown in FIG. 1A, the ink cartridge A comprises a container 10, an ink holder 20, a filter 30, a sealing mechanism 40, a sealing film 5, a cover 50 and ink W. The container 10 has an inner space 11 used to receive the ink holder 20 and covered by the cover 50. The ink holder 20 is made of porous material and used to temporally keep ink W therein. A port 12, located at the bottom of the container 10, has two openings 12-1, 12-2 (shown in FIG. 4A) and has a channel 120 (shown in FIG. 4A) used to connect the inner space of the container 10 to an ink supply needle 600. The filter 30 is mounted on the opening 12-2, which is formed on of the port 12 and located on the inner space 11 of the container 10. The sealing mechanism 40 made of elastic material such as rubber is used to fit in the port 12 from its opening 12-1, and then the sealing film 5 is used to cover the opening 12-1 of the port 12, as shown in FIG. 1B.

FIG. 2A shows the outer structure of the sealing mechanism 40 of FIG. 1A, and FIG. 2B shows the inner structure of the sealing mechanism 40 according to a cross-section plane Z1 of FIG. 2A. As shown in FIG. 2A, the sealing mechanism 40 is a cylindrical hollow member with two ends 41, 42. In FIG. 2B, one recess 410 is formed on the end 41 of the sealing mechanism 40 and is provided with an opening 1. Another recess 420 is indented from the end 42 of the sealing mechanism 40 and is provided with an opening 2, and the recess 420 connects the recess 410 via a hole 430.

FIG. 3A shows the ink supply needle 600 being inserted into the ink cartridge A, and FIG. 3B is a perspective view showing the assembly of FIG. 3A.

As shown in FIG. 3A, the ink supply needle 600 is a member used to guide the ink W out of the container 10. The ink supply needle 600 comprises a post 610 and a tip 610T on its free end, inlets 611 located nearby the tip 610T, and outlet nozzles 612 adjoining the inlet 611. User can insert the container 10 to the supply needle 600 by piercing the sealing film 5 with its tip 610T so that the ink supply needle 600 can be fixedly positioned in the ink cartridge A, as shown in FIG. 3B.

FIG. 4A shows the inner structure of the ink cartridge A according to a cross-section plane Z2 of FIG. 3B, and FIG. 4B is an enlarged view showing the region within the dot-line circle R1 of FIG. 4A.

As in FIG. 4A and 4B, the filter 30 is mounted on the opening 12-2 of the port 12, and the ink holder 20 abuts the filter 30. The filter 30 can remove impurities out of the drained ink W. As the container 10 is inserted with the ink supply needle 600, the ink supply needle 600 with its post 610 being fitted in the hole 430 (openings 2) of the sealing mechanism 40. Then, the ink W drained from the ink holder 20 is guided into the inlet 611 of the ink supply needle 600 and expelled out by the outlet nozzles 612.

However, as the ink cartridge A is completely pulled out of the ink supply needle 600, the penetrated sealing film 5 will no longer seal the opening 12-1 of the port 12 again.

### SUMMARY OF THE INVENTION

To solve the above problem, the primary object of this invention is to provide an ink cartridge for carrying ink and providing ink to a printhead. The ink cartridge comprises a container formed with an inner space and a base plate provided with a port, a sealing mechanism used to fit in the port. An ink supply needle is used to connect the inner space of the ink cartridge and output the ink. Several of capillary portions are formed on the inner sidewall of the port so as to keep the filter wet with ink. At one end of the sealing mechanism, a first recess is provided so as to be a positioning hole for the alignment of the ink supply needle, and a second recess is provided at the other end of the sealing mechanism so as to connect the inner space of the container. The ink supply needle formed with a tip and ink inlets is used to pierce the sealing mechanism with its tip and connected to the inner space of the container. Once the sealing mechanism is about to be inserted with the ink supply needle, the first recess of the sealing mechanism can rapidly align the ink supply needle. When the ink supply needle is fully inserted into the sealing mechanism, the pierced sealing mechanism clamps the ink supply needle and the ink in the container can be continuously transmitted via the ink supply needle. When the ink cartridge is pulled out of the ink supply needle, which used to be clamped by the sealing mechanism, the penetrated opening of the sealing mechanism can rapidly converges due to its elasticity and seals the port again, so the stored ink is kept in the container with no leakage throughout the port and is isolated to the atmosphere.

### BRIEF DESCRIPTION OF THE DRAWINGS

The present invention can be more fully understood by the subsequent detailed descriptions and examples with reference to perspective drawings in which:

FIG. 1A is an exploded perspective view showing the structure of one prior ink cartridge (A);

FIG. 1B is a perspective view showing the assembly according to FIG. 1A;

FIG. 2A is an enlarged perspective view showing the outer structure of the sealing mechanism (40) of FIG. 1A;

FIG. 2B is a cross-sectional view showing the inner structure of the sealing mechanism (40) according to a cross-section plane (Z1) of FIG. 2A;

FIG. 3A is a perspective view showing the ink cartridge (A) is about to be inserted with an ink supply needle (600);

FIG. 3B is a perspective view showing the assembly of FIG. 3A;

FIG. 4A is a cross-sectional view showing the inner structure of the ink cartridge (A) according to a cross-section plane (Z2) of FIG. 3B;

FIG. 4B is an enlarged view of the region within the dot-line circle (R1) of FIG. 4A;

FIG. 5A is an exploded perspective view of an ink cartridge (B) according to the present invention;

FIG. 5B is a perspective view showing the assembly according to FIG. 5A;

FIG. 6A is an enlarged perspective view showing the outer structure of the sealing mechanism (400) of FIG. 5A;

FIG. 6B is a cross-sectional view showing the inner structure of the sealing mechanism (400) according to a cross-section plane (Z4) of FIG. 6A;

FIG. 7A is a cross-sectional perspective view showing the inner structure of the ink cartridge (B) according to the cross-section plane (Z3) of FIG. 5B;

FIG. 7B is an enlarged perspective view of the region within the dot-line circle (R2) of FIG. 7A;

FIG. 8 is a perspective view showing an ink supply needle (600) being inserted into the ink cartridge (B);

FIG. 9A is a cross-sectional view showing the inner structure of the ink cartridge (B) according to a cross-section plane (Z5) of FIG. 8;

FIG. 9B is an enlarged view of the region within the dot-line circle (R3) of FIG. 9A;

FIG. 10 is a view showing the ink cartridge (B) being pulled out of the ink supply needle (600) according to FIG. 9B;

FIG. 11A is an enlarged perspective view showing the outer structure of the sealing mechanism (400) according to FIG. 10; and

FIG. 11B is a cross-sectional view showing the inner structure of the sealing mechanism (400) according to a cross-section plane (Z6) of FIG. 11A.

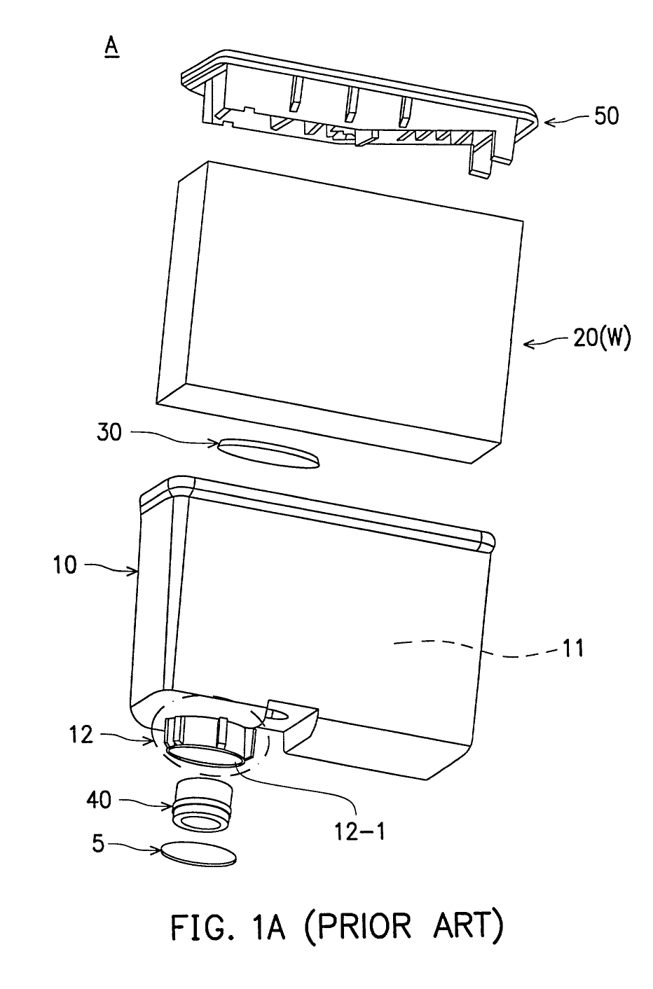

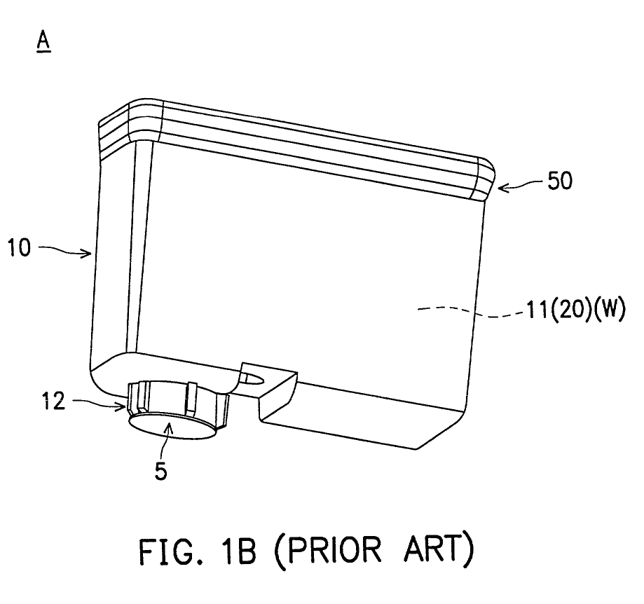

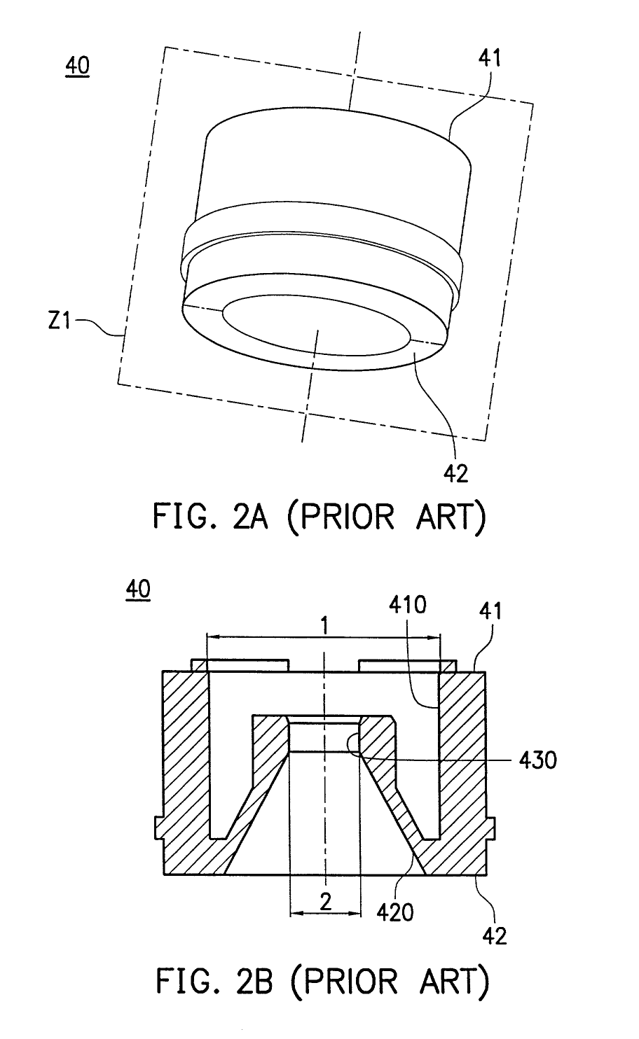

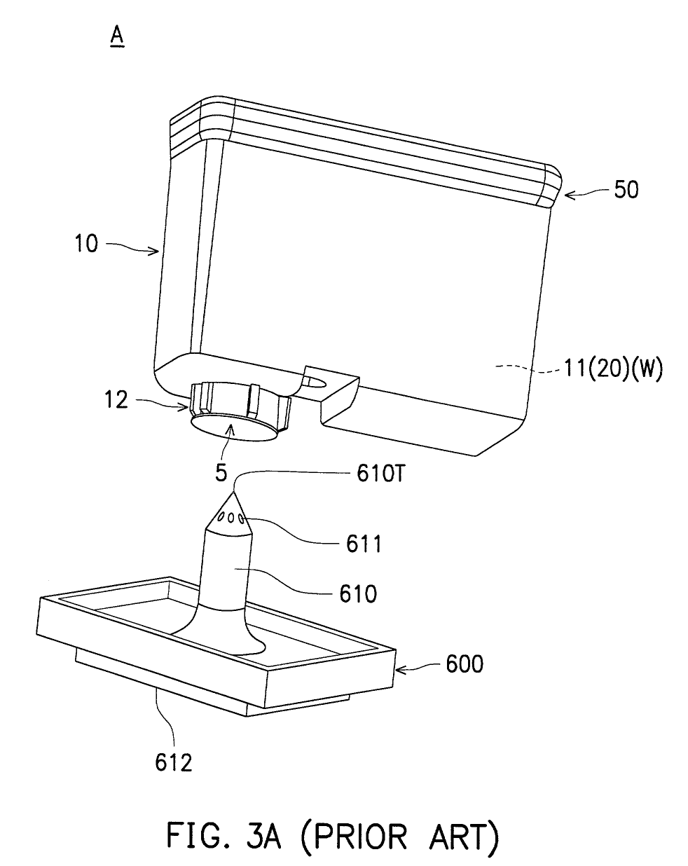

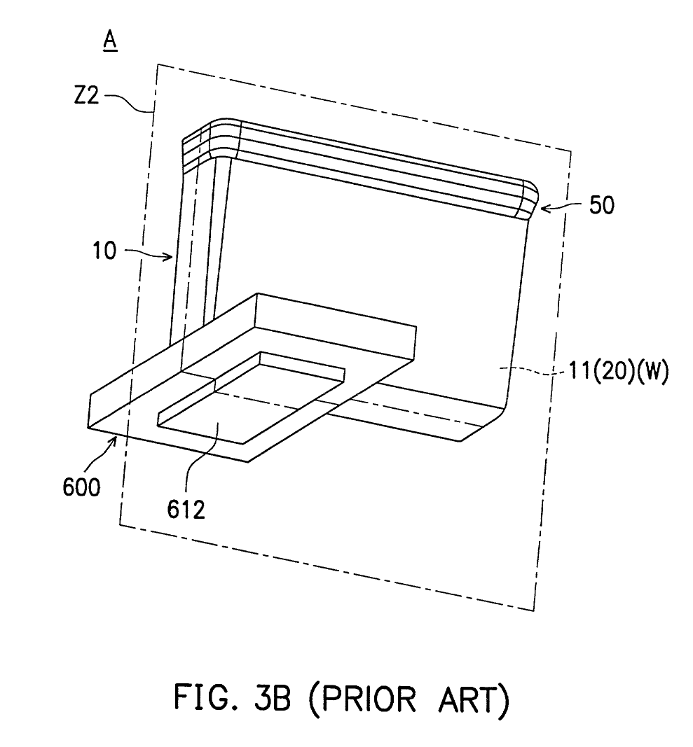

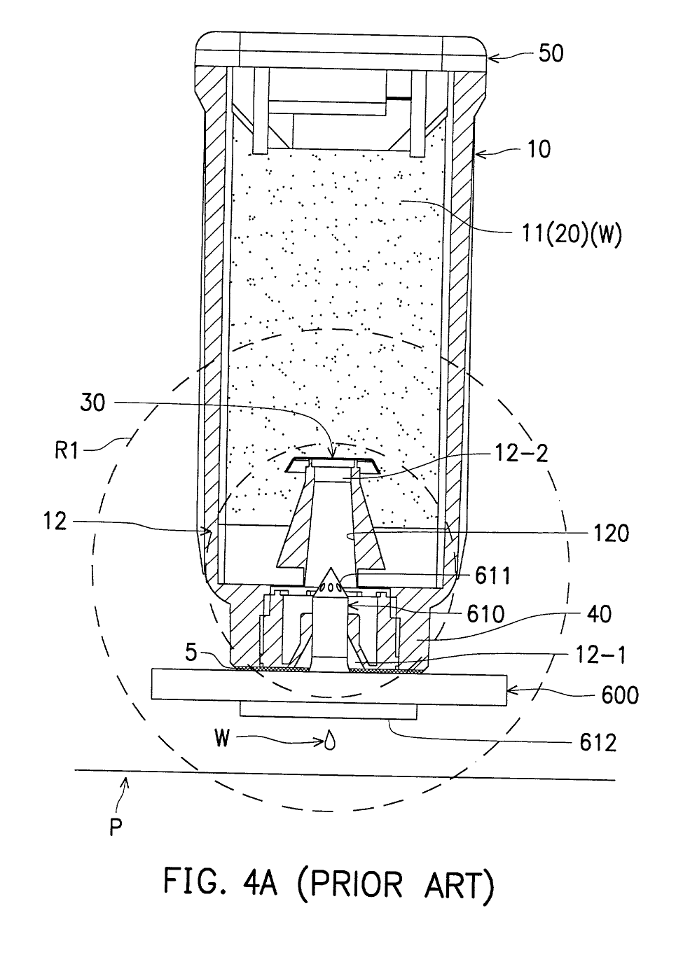

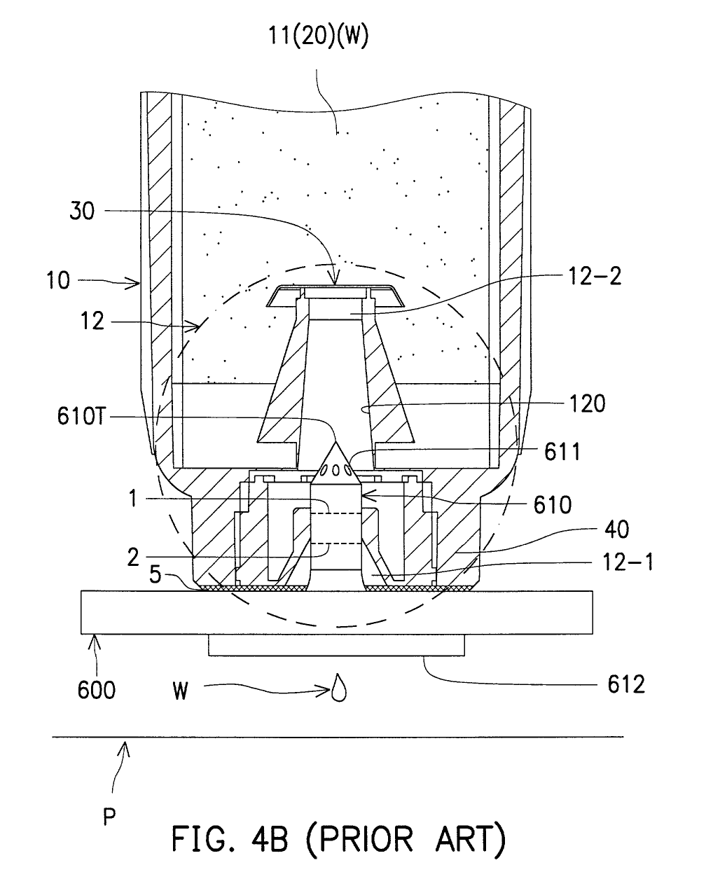

### DETAILED DESCRIPTION OF THE PREFERRED EMBODIMENTS

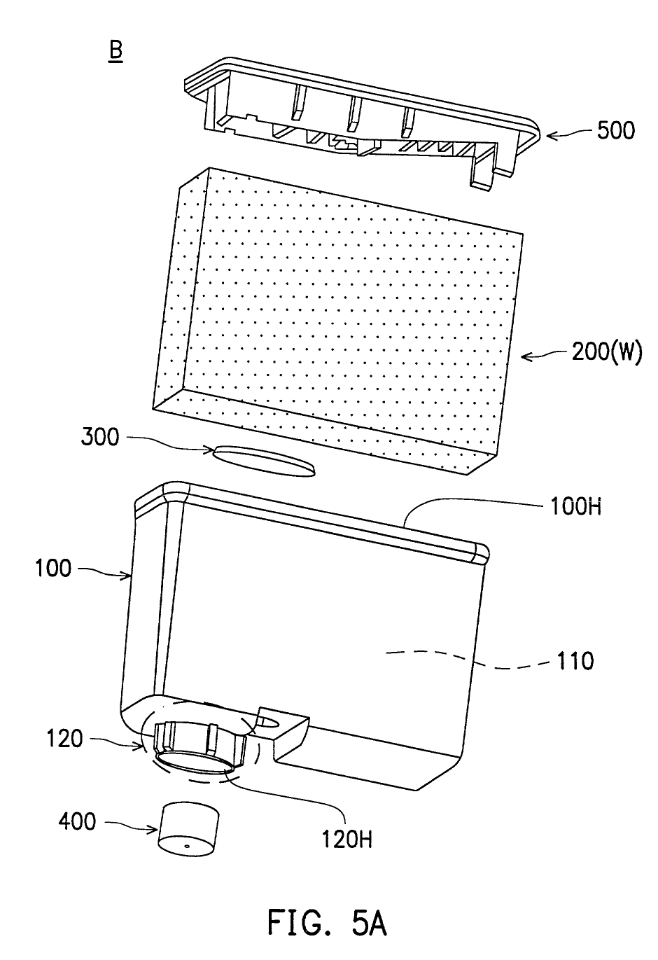

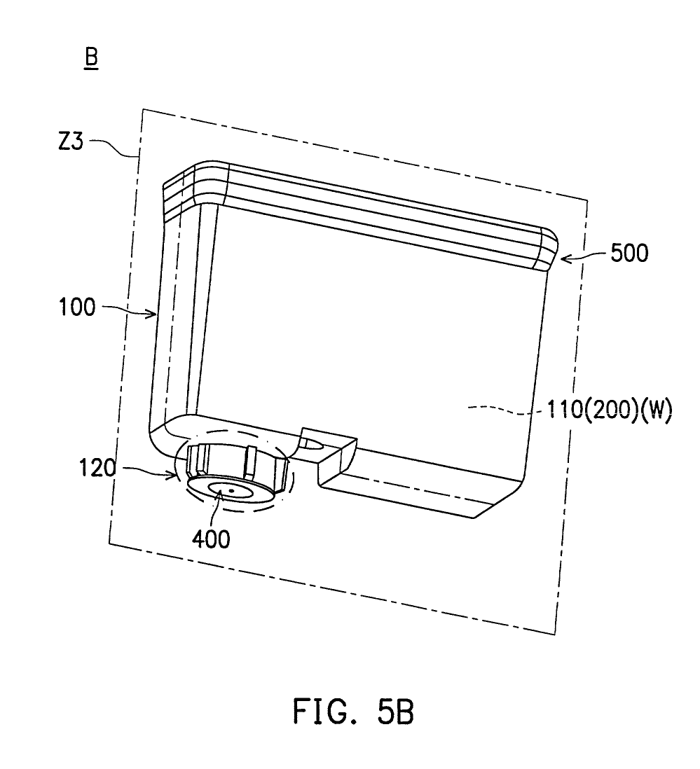

FIG. 5A is an exploded perspective view showing all elements of an ink cartridge B according to the present invention, and FIG. 5B is a perspective view showing the assembly according to FIG. 5A.

In FIG. 5A, the ink cartridge B comprises a container 100, an port 120 formed on the bottom plate of the container 100, an ink holder 200 and a sealing mechanism 400. An ink supply needle 600 (the same as the aforementioned and shown in other figures later) is a member used to guide the ink W out of the container 100.

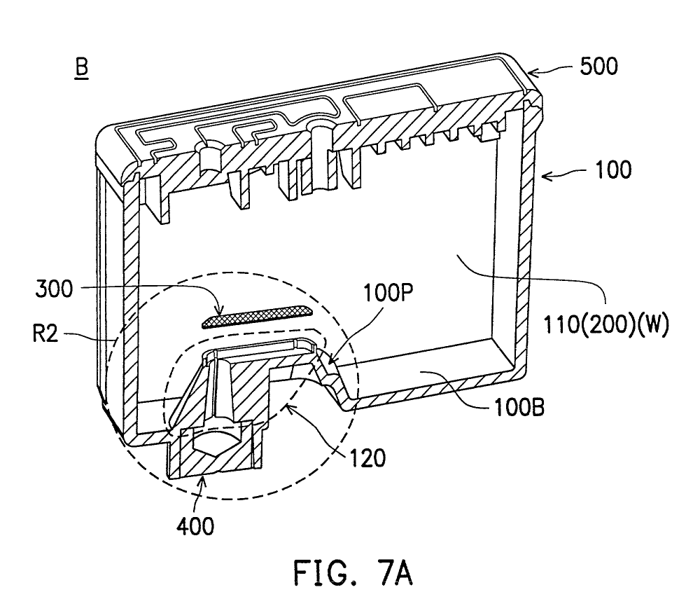

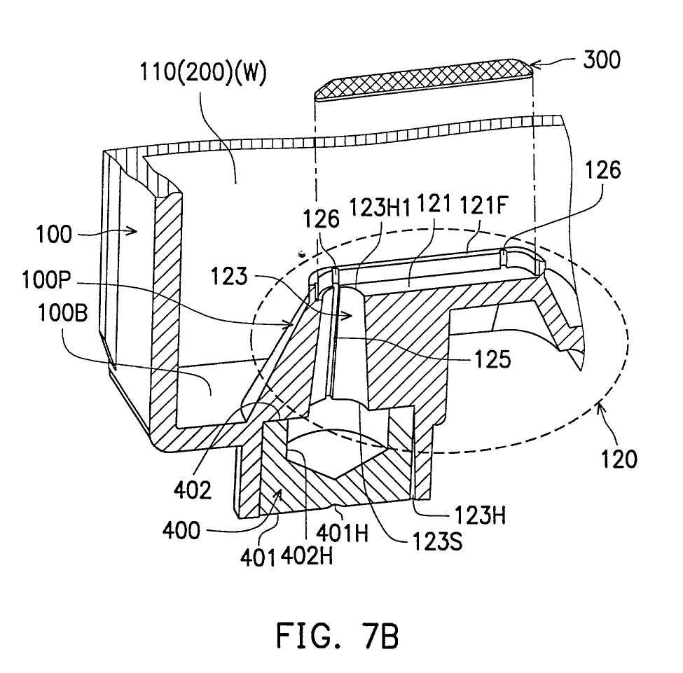

The container 100 has an inner space 110 which is used to receive the ink holder 200 and covered by the cover 500, and the ink holder 200 made of porous material is used to temporally keep ink W therein. The port 120 having an opening 123H (shown in FIG. 7B) is used as an ink passage connecting the inner space of the container 100 to the ink supply needle 600. The filter 300 is disposed on ink passage so as to remove impurities out of the drained ink W, and the sealing mechanism 400 is used to plug into the port 120 from the opening 123H, as shown in FIG. 5B.

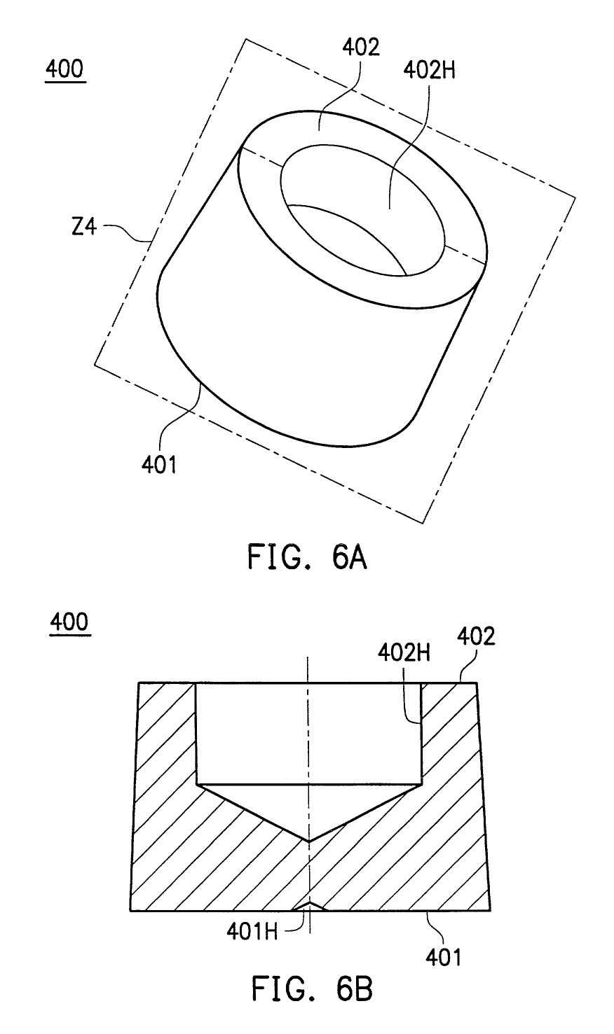

In FIG. 6A and 6B, the sealing mechanism 400 is a cylindrical member with two ends 401 and 402.

The first recess 401H, a positioning hole for the installation of the ink supply needle 600, is indented from the end 401 of the sealing mechanism 400. A second recess 402H, larger than first recess 401H in size, is indented from the end 402 of the sealing mechanism 400.

FIG. 7A shows a cross-sectional perspective view of the inner structure of the ink cartridge B according to the cross-section plane Z3 of FIG. 5B, and FIG. 7B shows an enlarged perspective view of the region within the dot-line circle R2 of FIG. 7A.

According to FIG. 7B, the port 120 comprises a protrusion 100P formed on the inner bottom surface 100B of the container 100, a base seat 121 formed on the protrusion 100P and wrapped with a flange 121F, a channel 123 and several capillary portions 125, 126. The channel 123 is a through hole having two openings 123H, 123H1 respectively connecting the ink supply needle 600 and the inner space 110. A step portion 123S is provided in the channel 123 and used to position the sealing mechanism 400. The filter 300 is mounted on the top of the flange 121F and fully covers the base seat 121 and the opening 123H1. The capillary portions 125 is a longitudinal slot formed on the inner sidewall of the channel 123 and connecting the opening 123H1 to the step portion 123S. The capillary portions 126 are slots respectively formed on the sidewall of the flange 121F and extended to the base seat 121, and a couple of which are connected to the capillary portion 125.

As the ink holder 200 with ink W is completely placed in the inner space 110 of the container 100, the ink holder 200 abuts the filter 300. By the capillary portions 126, the ink W stored in the ink holder 200 can be filtered by the filter 300 and continuously flow to base seat 121 by the capillary portions 126 and. Then, the filtered ink W flows to the second recess 402H through the channel 123, and the filter 300 can be kept wet with the ink W by the capillary portions 125.

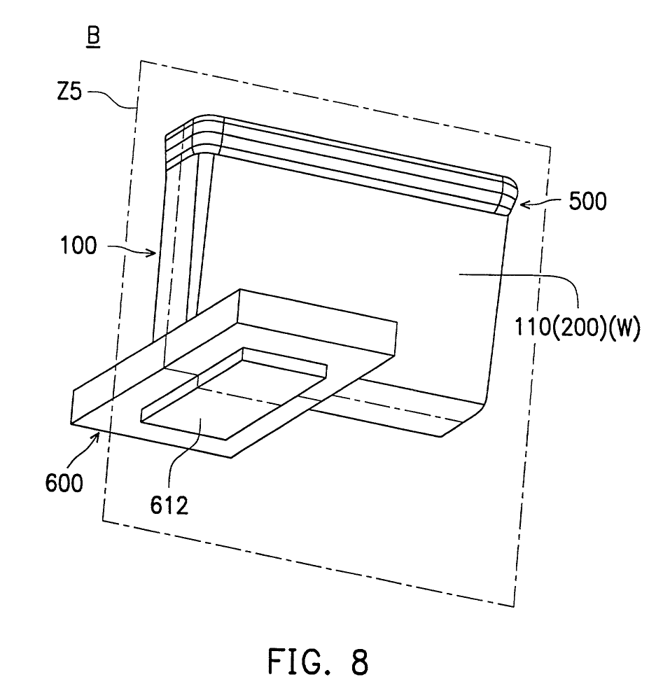

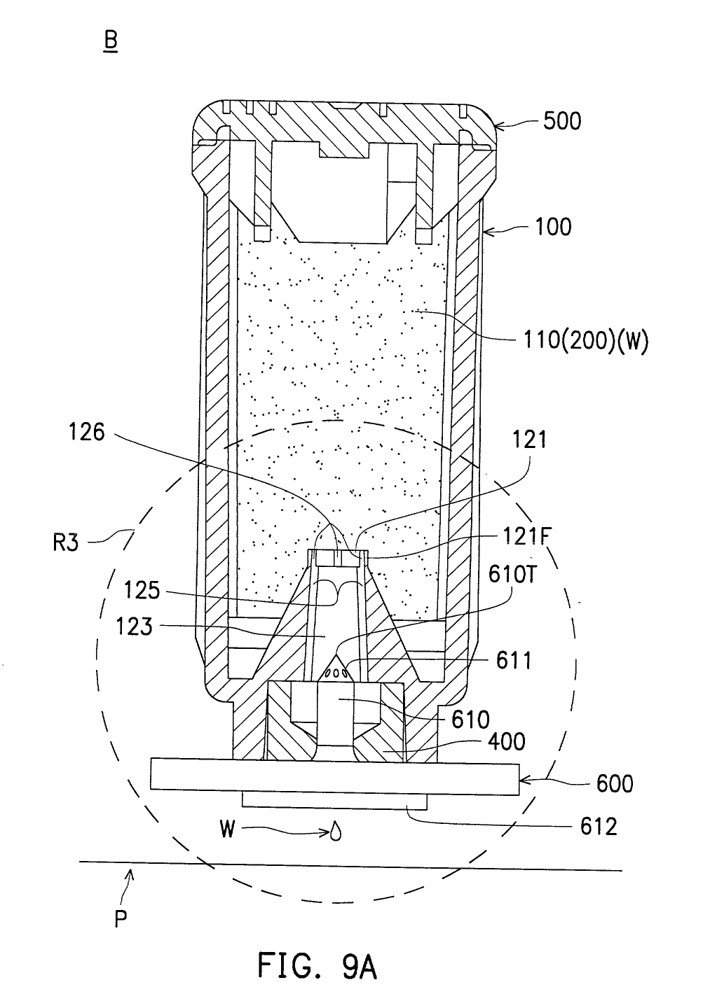

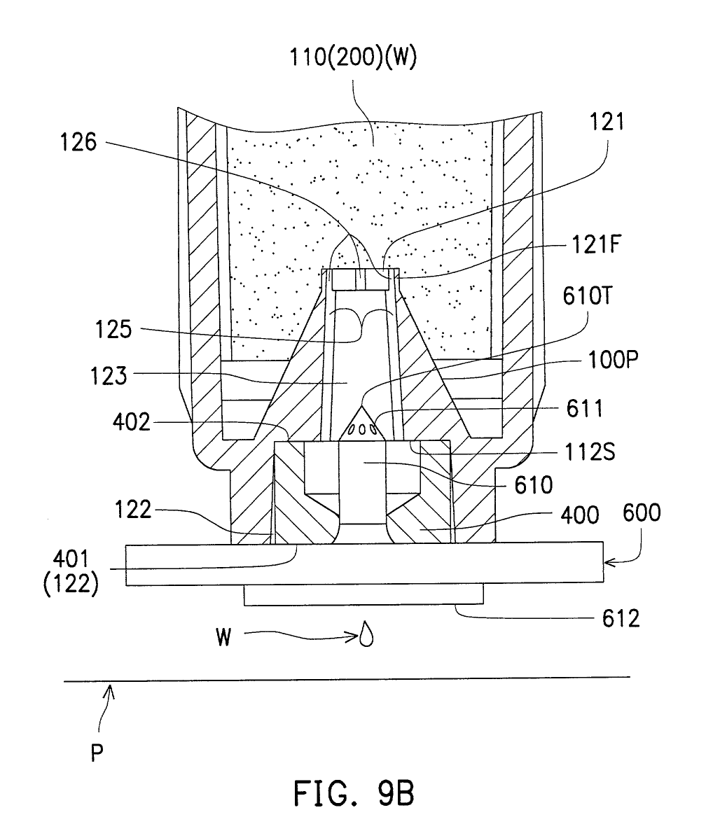

In FIG. 8, a perspective view shows that the ink cartridge B is inserted with the ink supply needle 600. According to FIG. 9A, as the ink supply needle 600 is inserted into the sealing mechanism 400, the tip 610T of the ink supply needle 600 can be easily positioned by pressing against on the first recess 401H of the sealing mechanism 400.

FIG. 9A is a cross-sectional view showing the inner structure of the ink cartridge B according to a cross-section plane Z5 of FIG. 8, and FIG. 9B shows an enlarged view within the dot-line circle R3 of FIG. 9A.

As shown in FIG. 9A, the tip 610T of the ink supply needle 600 penetrates the sealing mechanism 400 and then the post 610 is tightly clamped by the sealing mechanism 400 when the sealing mechanism 400 receives the ink supply needle 600. Then, the ink supply needle 600 can be positioned when the post 610 is fully inserted, and its inlets 611 is located inside the channel 123 and immersed in the ink W. Further, according to the design of the capillary portions 125, 126 formed on the passage of the ink W, the channel 123 of the port 120 can be always kept wet by the ink W. Thus, the ink W received in the channel 123 can be smoothly and continuously transmitted via the ink supply needle 600 and then outputted to a predetermined printing media P by the outlet nozzles 612 of the ink supply needle 600.

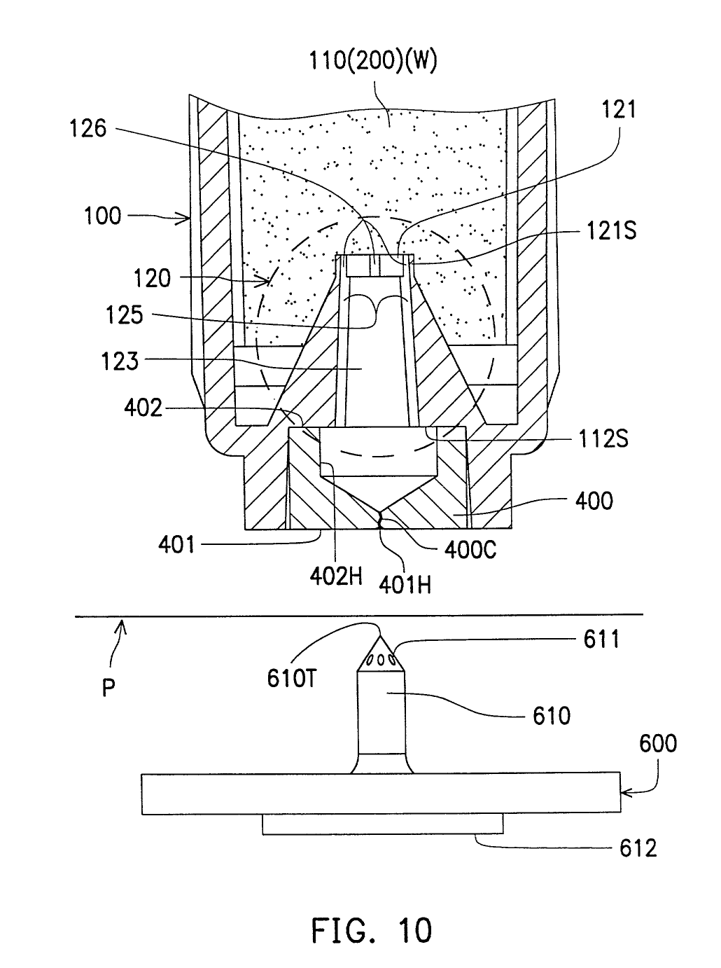

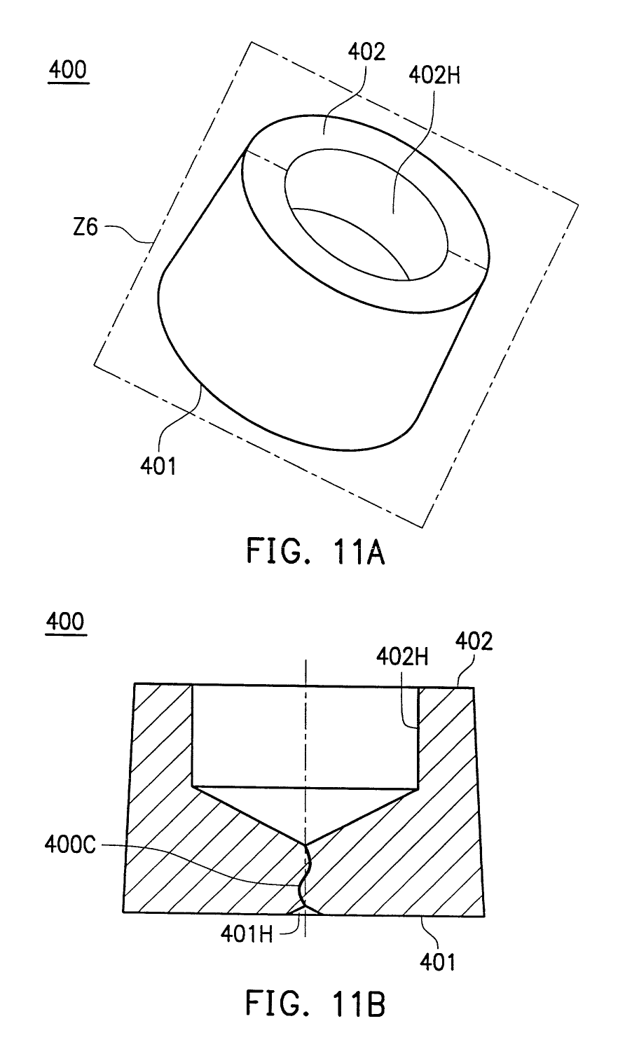

Referring to FIG. 10, a plan view shows the ink supply needle 600 being pulled out of the ink cartridge B according to FIG. 9B. Referring also to FIG. 11A and FIG. 11B, FIG. 11A is an enlarged perspective view showing the outer structure of the sealing mechanism 400 according to FIG. 10, and FIG. 11B shows the inner structure of the sealing mechanism 400 which has been penetrated by the ink supply needle 600 according to a cross-section plane Z6 of FIG. 11A.

As shown in FIG. 10 and FIG. 11B, the penetrated opening 400C of sealing mechanism 400 rapidly converges and seales the port 120 again as soon as the clamped ink supply needle 600 is pulled out of the sealing mechanism 400. Therefore, the stored ink W is kept in the container 100 with no leakage throughout the port 120 and is isolated to the atmosphere.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An ink cartridge for carrying ink which is outputted by an ink supply needle, comprising:
a container having an inner space to receive the ink;
a port disposed on the container, having a channel connected the inner space and used to transmit the ink; and
a sealing mechanism fitted in the port to seal the port all the time even after the ink cartridge is pulled out of the ink supply needle.

2. The ink cartridge as claimed in claim 1, wherein the sealing mechanism has a closed end toward the ink supply needle.

3. The ink cartridge as claimed in claim 1 further comprising an ink holder disposed in the inner space and used to hold the ink therein.

4. The ink cartridge as claimed in claim 1, wherein the sealing mechanism is provided with a positioning hole.

5. The ink cartridge as claimed in claim 1, wherein the sealing mechanism is made of elastic material.

6. The ink cartridge as claimed in claim 2 wherein the ink holder is made of porous material.

7. An ink cartridge for carrying ink which is outputted by an ink supply needle, comprising:
a container having an inner space to receive the ink;
a port disposed on the container, having a channel provided with capillary portions and connected the inner space to transmit the ink;
an ink holder disposed in the inner space and used to hold the ink therein; and
a sealing mechanism fitted in the port to seal the port all the time even after the ink cartridge is pulled out of the ink supply needle.

8. The ink cartridge as claimed in claim 7, wherein the capillary portions are slots formed on the inner wall of the channel.

9. The ink cartridge as claimed in claim 7, wherein the sealing mechanism is provided with a positioning hole.

10. The ink cartridge as claimed in claim 7, wherein the sealing mechanism is made of elastic material.

11. The ink cartridge as claimed in claim 6, wherein the ink holder is made of porous material.
